(19) United States
(12) Patent Application Publication
(10) Pub. No.: US 2014/0289184 A1
(43) Pub. Date: Sep. 25, 2014

(54) LICENSE STRUCTURE REPRESENTATION FOR LICENSE MANAGEMENT

(71) Applicants: Sanjeev Kumar Biswas, New Delhi (IN); Akash Jain, Meerut (IN); Kanika Dalmia Gupta, New Delhi (IN)

(72) Inventors: Sanjeev Kumar Biswas, New Delhi (IN); Akash Jain, Meerut (IN); Kanika Dalmia Gupta, New Delhi (IN)

(21) Appl. No.: 12/555,875

(22) Filed: Sep. 9, 2009

(51) Int. Cl. G06F 17/30

(52) U.S. Cl. 707/607; 707/E17.014; 707/E17.044; 707/636

(57) ABSTRACT

Embodiments herein include a license provisioning application that organizes licensing information into a licensing data structure in a multi-application environment. The license provisioning application can use the licensing data structure to increase the efficiency of license management operations by representing complex licenses and their relationships, including locale-based licensing and flexible licensing frameworks. The license provisioning application includes a caching mechanism for faster performance, and facilitates ease of use for license management operations, such as activation, renewal, and deactivation (both in bulk and individually), handling subscription based licensing, trial licensing, and executing license queries. The license provisioning application can provide a graphical representation of licenses and relationships for performing various license management operations.

### BACKGROUND

The present disclosure relates to license management including managing licenses of software applications. A software license is an instrument that grants permission to use a given software application or software product. Software developers typically derive revenue from their software products by selling licenses that permit use of these software products, instead of selling ownership of the software products themselves.

A common use case of software licensing is that one or more software applications are installed on a computing device, such as a desktop personal computer. The computing device might only execute or run those software applications having a valid license. For example, upon launching a particular software program, the software program can execute a background process to determine if there is a valid license to continue running the software program. If a valid license is found, then the software program continues loading and operates normally. If a valid license is missing, then the software program might close or otherwise prevent operation of program functionality. Thus, license management can be an important part of software operation.

License management can become more important as the number of installed software products, on a given computing device, increases. For example, a given desktop personal computer might have dozens (or hundreds or more) of installed software applications. Each software application can be a different version of a previously-installed application. Additionally, each software application can have different types of licenses stored in different locations.

### SUMMARY

Information, associated with software licensing, can be spread across multiple files and storage locations (both local and remote), and can include different types of licenses, such as trial licenses, limited functionality licenses, full functionality licenses, language specific licenses, etc. For example, in a multiple application scenario on a particular computing device, there can be different types of licenses for different applications. Each license can vary in the way the license grants permission to use an associated software application. Additionally, there can be multiple licenses available for a particular product existing within a flexible licensing framework. With multiple stored licenses for an individual product, there can be a priority order of licenses indicating which licenses dominate, supersede, or otherwise take priority over other licenses. Such a license dominance list can be ordered according to application installation date, purchase date, version sequence, or can be ordered by other criteria.

Some software developers distribute software products as a suite or collection of interrelated applications. Licensing information for such a suite of related products can contain both group and individual licenses, as well as locale-based licenses (language specific), and flexible licensing strategies. All this licensing information can be spread around different storage locations and stored at different times. Additionally, there can be multiple licenses associated with a specific product within a suite of products. By way of a non-limiting example, a given suite of software products might contain a graphics editor, a desktop publisher, a digital audio editor, and a web development application. In this example, prior to installing this suite of software products, the graphics editor might already be installed and licensed as an independent application on the computing device. Upon installing and licensing this suite of software products on the computing device, there now exists multiple licenses for the graphics editor. That is, the graphics editor is licensed both individually and licensed by the suite of software products. Subsequently, a second suite of software products might be installed and licensed. This second suite might add several more applications to the first suite (such as a video editor, and a vector graphics program), while including licenses for all of the applications in the first suite, including the graphics editor. At this point, the computing device contains an additional license for the graphics editor.

As the number of installed applications and suites increases, the number and type of stored licenses multiplies. Thus, license management for all the available licenses becomes a complicated process that is extremely difficult to manage. Techniques discussed herein may significantly overcome the challenges of license management in a multiple application environment. For example, as will be discussed further, certain specific embodiments herein are directed to a license provisioning application that organizes licensing information into a licensing data structure. The license provisioning application can use such a sophisticated licensing data structure to increase the efficiency of license management operations by representing complex licenses and their relationships. The license provisioning application can include a caching mechanism for faster performance. The license provisioning application can facilitate ease of use for license management operations, such as activation, renewal, and deactivation (both in bulk and individually), handling subscription based licensing, trial licensing, and executing license queries. The license provisioning application can provide a graphical representation of licenses and relationships for performing such license management operations.

For example, as will be discussed further, certain specific embodiments herein are directed to a license provisioning application that facilitates management of licenses for software products operating on a computing device. The license provisioning application identifies licensing information for a group of software products. This licensing information can be located within one or more files or databases, and stored locally and/or remotely. The group of software products can be any group of software products (interchangeably know as software applications), programs, binaries, etc. The group of software products can be defined by any criteria. For example, software products can be grouped by applications installed on a specific machine, by developer/owner of specific software products, by type of software products (utility, design), by user profile, or by any other suitable basis for inclusion in the group of software products. Each software product has at least one licensing entity identifier (LEID). The license entity identifier is an identified software unit that can be licensed. The license entity identifier can be one payload, or a group of payloads. A payload is an installable part of an application.

In one embodiment, The license provisioning application creates a licensing structure node for each identified licensing entity identifier, and then populates each licensing structure node with corresponding licensing information from the multiple storage locations. Such licensing information can include, for example, identities of installed payloads, serial numbers of installed payloads, names of applications, application status, license types, locales, and so forth. The license provisioning application can also obtain, as part of the licensing information, a dominance list of license entity identifiers, and maintain a map identifying which LEIDs supersede or take priority over other LEIDs.

The license provisioning application organizes the licensing structure nodes into a hierarchical licensing data structure based on dominance relationships among the licensing structure nodes. Internally, the licensing data structure can be arranged with root nodes for individually installed applications and application suites, and then child nodes for applications licensed within a suite. The license provisioning application then executes license management for the group of software products using the nodes and the hierarchical licensing data structure. The licensing data structure provides a basis for graphically displaying relationships among licensed payloads/applications installed on a given device. Such a graphical display enables efficient activation, deactivation, renewal, or other modification/management operations to licensed software products, including uninstallation. For example, the license provisioning application can provide activation and deactivation operations in bulk using a single click, and can filter displayed licenses based on a parameter such as a specific language license, product name, and so on.

In addition to the example method, product, system, etc., embodiments as discussed above, and other embodiments herein, can include a configuration of one or more computerized devices, websites, servers, hosted services, workstations, handheld or laptop computers, or the like to carry out and/or support any or all of the method operations disclosed herein. In other words, one or more computerized devices or processors can be programmed and/or configured to include a license provisioning application and/or related functions as explained herein to carry out different embodiments as described herein.

Yet other embodiments herein include software programs to perform the steps and operations summarized above and disclosed in detail below. One such embodiment comprises a computer program product that has a computer-storage medium (e.g., a tangible computer readable media, disparately located or commonly located storage media, computer storage media or medium, etc.) including computer program logic encoded thereon that, when performed in a computerized device having a processor and corresponding memory, programs the processor to perform the operations disclosed herein. Such arrangements are typically provided as software, firmware, microcode, code data (e.g., data structures), etc., arranged or encoded on a computer readable storage medium such as an optical medium (e.g., CD-ROM), floppy disk, hard disk, one or more ROM or RAM or PROM chips, an Application Specific Integrated Circuit (ASIC), and so on. The software or firmware or other such configurations can be installed onto a computerized device to cause the computerized device to perform the techniques explained herein.

Accordingly, one particular embodiment of the present disclosure is directed to a computer program product that includes one or more computer storage media having instructions stored thereon for supporting operations such as: identifying licensing information for a group of software products, the licensing information located at multiple storage locations, each software product having at least one licensing entity identifier; creating a licensing structure node, for each identified licensing entity identifier, and populating each licensing structure node with corresponding licensing information from the multiple storage locations; organizing the licensing structure nodes into a hierarchical licensing data structure based on dominance relationships among the licensing structure nodes; and, executing license management for the group of software products using the nodes and the hierarchical licensing data structure. The instructions, and method as described herein, when carried out by a processor of a respective computer device, cause the processor to perform the methods disclosed herein.

Other embodiments of the present disclosure include software programs to perform any of the method embodiment steps and operations summarized above and disclosed in detail below.

Of course, the order of discussion of the different steps as described herein has been presented for clarity sake. In general, these steps can be performed in any suitable order.

Also, it is to be understood that each of the systems, methods, apparatuses, etc. herein can be embodied strictly as a software program, as a hybrid of software and hardware, or as hardware alone such as within a processor, or within an operating system or within a software application, or via a non-software application such a person performing all or part of the operations. Example embodiments as described herein may be implemented in products and/or software applications such as those manufactured by Adobe Systems Incorporated of San Jose, Calif., USA.

As discussed above, techniques herein are well suited for use in software applications supporting licensing of multiple applications such as a suite or collection of software products. It should be noted, however, that embodiments herein are not limited to use in such applications and that the techniques discussed herein are well suited for other applications as well.

Additionally, although each of the different features, techniques, configurations, etc. herein may be discussed in different places of this disclosure, it is intended that each of the concepts can be executed independently of each other or in combination with each other. Accordingly, the present invention can be embodied and viewed in many different ways.

Note that this summary section herein does not specify every embodiment and/or incrementally novel aspect of the present disclosure or claimed invention. Instead, this summary only provides a preliminary discussion of different embodiments and corresponding points of novelty over conventional techniques. For additional details and/or possible perspectives of the invention and embodiments, the reader is directed to the Detailed Description section and corresponding figures of the present disclosure as further discussed below.

### BRIEF DESCRIPTION OF THE DRAWINGS

The foregoing and other objects, features, and advantages of the invention will be apparent from the following more particular description of preferred embodiments herein as illustrated in the accompanying drawings in which like reference characters refer to the same parts throughout the different views. The drawings are not necessarily to scale, with emphasis instead being placed upon illustrating the embodiments, principles and concepts.

FIG. 1 is an example diagram of a license provisioning application for processing of licensing information in a computer/network environment according to embodiments herein.

FIG. 2 is an example block diagram of a license provisioning application operating in a computer/network environment according to embodiments herein.

FIG. 3 is a flowchart illustrating an example of a process supporting a license provisioning application according to embodiments herein.

FIGS. 4-6 are example diagrams of a licensing data structure according to embodiments herein.

FIG. 7 is a screen shot of an example license provisioning application showing deactivation options for a group of software products according to embodiments herein.

FIG. 8 is a screen shot of an example license provisioning application showing uninstall options for a group of software products according to embodiments herein.

### DETAILED DESCRIPTION

According to one example embodiment, a license provisioning application facilitates management of licenses for software products operating in a multi-application environment. License management for all available licenses is typically a complicated task because each license can be located in different locations on a machine, and each license can have a different licensing strategy (such as locale-based licensing or flexible licensing). According to one embodiment, the license provisioning application as described herein provides efficient license management.

For example, the license provisioning application identifies licensing information for a group of software products. This licensing information can be located within one or more files or databases, and stored locally and/or remotely. The group of software products can be any plurality of software applications, programs, binaries, etc. By way of a non-limiting example, a group of software products might include software products manufactured by a specific company, entity, or software developer. In another example, the group might include software products of a specific utility, such as web-related software products. Conventionally, some companies distribute software products in suites or sets of software products. The group can also include a combination of one or more software suites and/or stand alone software products.

In one embodiment, each software product has at least one licensing entity identifier (LEID). The license entity identifier specifies a software unit that can be licensed. The license provisioning application creates a licensing structure node for each identified licensing entity identifier, and then populates each licensing structure node with corresponding licensing information from the multiple storage locations. As an example, such licensing information can include fields for identities of installed payloads, serial numbers of installed payloads, names of applications, application status, license types, locales, and so forth. The license provisioning application can also obtain, as part of the licensing information, a dominance list of license entity identifiers, and maintain a map identifying which LEIDs supersede or take priority over other LEIDs.

With respect to dominance relationships, a point product is dominated by another product if the point product can be licensed by the other product. A dominance relationship can exist when a point product is part of a suite of products and the license of the suite product can be used to license the point product. At the time of installation of a product, a product's installation database is updated with the dominance relationship for the point product. Such dominance relationships can be maintained in a product configuration database to maintain products and dominating products. An example license database can include, for each entry, fields for a domain, subdomain, key, and value. The subdomain can represent the dominance relationship between the key and the value. The key can be a product LEID (for example a specific graphics application) that can be dominated (licensed) by any of the values. The values can include one or more application suites or groups.

The license provisioning application organizes the licensing structure nodes into a hierarchical licensing data structure based on dominance relationships among the licensing structure nodes. Internally, the licensing data structure can be arranged with root nodes for individually installed applications and application suites, and then child nodes for applications licensed within a suite. The license provisioning application then executes license management for the group of software products using the nodes and the hierarchical licensing data structure.

License management operations can include a query to the license provisioning application. For example, a device operator might want to view all of the licenses on a particular machine to deactivate or otherwise manage licenses. In response to such a query, the license provisioning application returns a licensing data structure that can include license information about some or all licenses on a desktop personal computer, or other computing device. Licensing data structure can be organized as an array of linked nodes where a root node corresponds to a self-licensed product, whose license corresponds to a valid serial number, activated by a license server. The root node also corresponds to a license document file, (in a local database) associated with the self-licensed product. The licensing data structure for all the products licensed and/or dominated by this self-licensed product are present in a linked list of the root node.

Such a licensing data structure returned from the query can depict a relationship among different products and the associated licenses. This licensing data populated for all the available licenses on a particular computing device can be used for license management and performing deactivation at uninstall.

For license management, the license data populated in the licensing data structure can be used to provide a user interface for managing existing licenses. The user interface can display a list of licensed products, along with corresponding licensing data and a list of products dominated/licensed by them and the actions available for selection. For instance, a screen on this user interface can be used to deactivate a given license by clicking a “Help” menu function followed by selecting a “Deactivate” menu item for a particular product associated with the given license. Such a user interface can display a product license hierarchy, using the license structure created by the license provisioning application in response to the license query, along with displaying an option to deactivate any of multiple licenses. Such displayed information is useful in case of flexible licensing where many point products (individual applications) are being licensed by a suite license.

Flexible licensing and locale-based licensing are two licensing strategies or licensing frameworks. Flexible licensing provides a flexible relationship between a point product (self-licensed or individual application within a suite) and suite installation and licenses. Flexible licensing supports many use cases. For example, flexible licensing can support a point product installed as a point product and licensed by a point product serial number. Flexible licensing can support a point product installed as point product and licensed as a suite by a suite serial number. Flexible licensing can support a point product installed as a suite and licensed as a suite by a suite serial number. Flexible licensing can support a point product installed as a suite and licensed by a point product serial number. Flexible licensing can support a point product installed as a suite and licensed as some other suite by serial number of some other suite.

By way of a non-limiting example of flexible licensing, a given suite or collection of software products might contain a graphics editor, a desktop publisher, a digital audio editor, and a web development application. In this example, prior to installing this suite of software products, the graphics editor might already be installed and licensed as an independent application on the computing device. Upon installing and licensing this suite of software products on the computing device, there now exists multiple licenses for the graphics editor. That is, the graphics editor is licensed both individually and licensed by the suite of software products. Subsequently, a second suite of software products might be installed and licensed. This second suite might add several more applications to the first suite (such as a video editor, and a vector graphics program), while including licenses for all of the applications in the first suite, including the graphics editor. At this point, the computing device contains an additional license for the graphics editor. In such flexible licensing in multiple application scenarios, the number of applications can grow, and thus managing licenses becomes difficult because licenses are stored in multiple places across different databases.

In locale-based licensing (by geography or language, etc.), a point product can be serialized and licensed by a locale-specific serial number. Serial numbers can be stored per locale under licensing code. Under this licensing strategy, it is possible that a same product is serialized by multiple locales. For example, a given software product was first released in English and then subsequently released in German, or French. To run the given software product in a specific language, many conventional software products require a language specific serial number. Thus, with many different applications and many different languages for each application, the number of serial numbers can grow significantly.

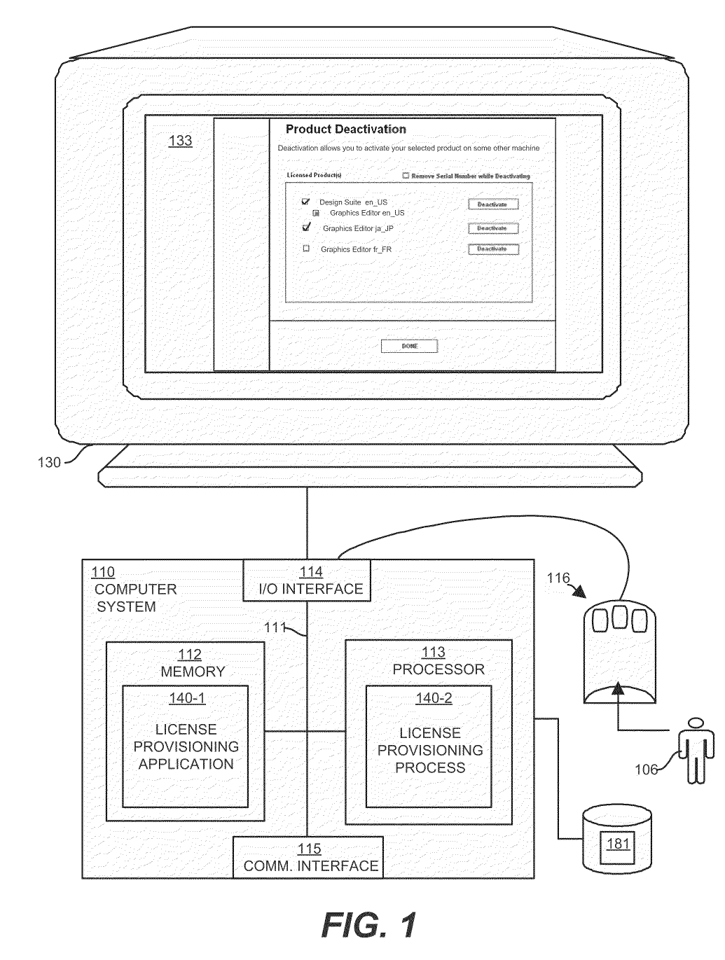

Now more particularly, FIG. 1 shows a general overview of the license provisioning application and how it can be tied to an example physical apparatus, such as a computer and related components. After this description of FIG. 1 appears a more detailed description of processes and methods executed by the license provisioning application itself. This subsequent description will explain the diagrams and the flow charts and reference screen shots in the drawings.

In FIG. 1, computer system 110 is shown connected to display monitor 130 for displaying a graphical user interface 133 for a user 106 to use a license provisioning application 140 for managing licenses, using input devices 116, including deactivation and removal of software products. Repository 181 can optionally be used for storing licensing information and other data both before and after processing. Input devices 116 can include one or more devices such as a keyboard, computer mouse, etc.

Note that the following discussion provides a basic embodiment indicating how to carry out functionality associated with the license provisioning application 140 as discussed above and below. It should be noted, however, that the actual configuration for carrying out the license provisioning application 140 can vary depending on a respective application. For example, as previously discussed, computer system 110 can include one or multiple computers that carry out the processing as described herein.

In different embodiments, computer system 110 may be any of various types of devices, including, but not limited to, a personal computer system, desktop computer, laptop, notebook, or netbook computer, mainframe computer system, handheld computer, workstation, network computer, application server, storage device, a consumer electronics device such as a camera, camcorder, set top box, mobile device, video game console, handheld video game device, or in general any type of computing or electronic device.

As shown, computer system 110 of the present example includes an interconnect 111 that couples a memory system 112, a processor 113, I/O interface 114, and a communications interface 115.

I/O interface 114 provides connectivity to peripheral devices such as input devices 116 including a computer mouse, a keyboard, a selection tool to move a cursor, display screen, etc.

Communications interface 115 enables the license provisioning application 140 of computer system 110 to communicate over a network and, if necessary, retrieve any data required to create views, process content, communicate with a user, etc. according to embodiments herein.

As shown, memory system 112 is encoded with license provisioning application 140-1 that supports functionality as discussed above and as discussed further below. License provisioning application 140-1 (and/or other resources as described herein) can be embodied as software code such as data and/or logic instructions that support processing functionality according to different embodiments described herein.

During operation of one embodiment, processor 113 accesses memory system 112 via the use of interconnect 111 in order to launch, run, execute, interpret or otherwise perform the logic instructions of the license provisioning application 140-1. Execution of the license provisioning application 140-1 produces processing functionality in license provisioning application process 140-2. In other words, the license provisioning application process 140-2 represents one or more portions of the license provisioning application 140 performing within or upon the processor 113 in the computer system 110.

It should be noted that, in addition to the license provisioning application process 140-2 that carries out method operations as discussed herein, other embodiments herein include the license provisioning application 140-1 itself (i.e., the un-executed or non-performing logic instructions and/or data). The license provisioning application 140-1 may be stored on a tangible computer readable storage medium including computer readable storage media such as floppy disk, hard disk, optical medium, etc. According to other embodiments, the license provisioning application 140-1 can also be stored in a memory type system such as in firmware, read only memory (ROM), or, as in this example, as executable code within the memory system 1012.

In addition to these embodiments, it should also be noted that other embodiments herein include the execution of the license provisioning application 140-1 in processor 113 as the license provisioning application process 140-2. Thus, those skilled in the art will understand that the computer system 110 can include other processes and/or software and hardware components, such as an operating system that controls allocation and use of hardware resources, or multiple processors.

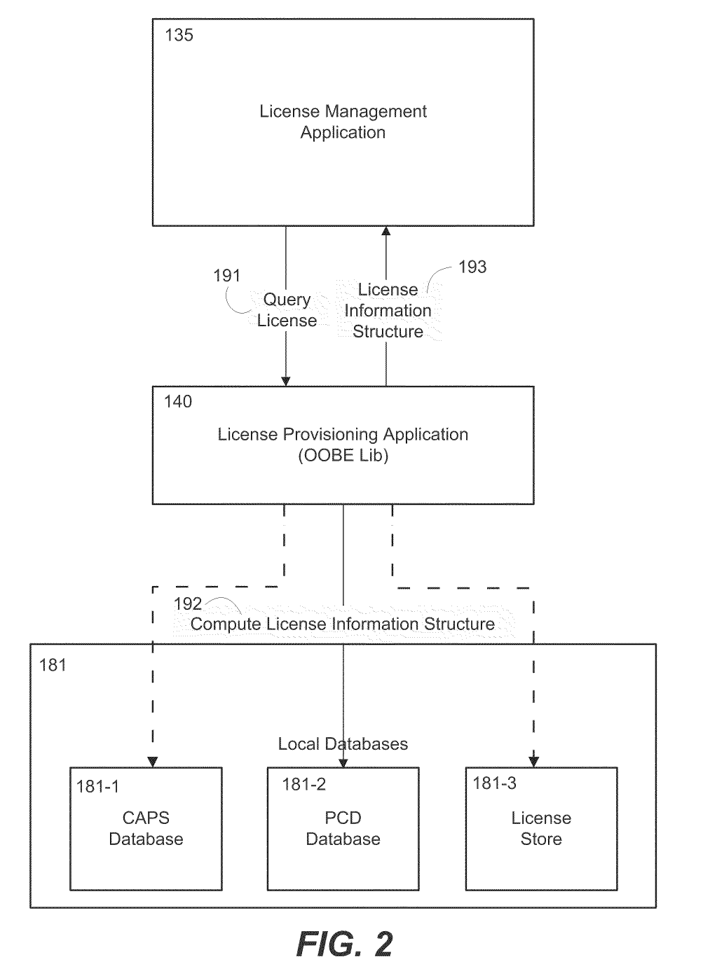

Functionality supported by computer system 110 and, more particularly, functionality associated with license provisioning application 140 will now be discussed via diagrams and flowcharts in FIG. 2 through FIG. 6. For purposes of the following discussion, the license provisioning application 140 or other appropriate entity performs steps in the flowcharts.

Now describing embodiments more specifically, FIG. 2 depicts an example block diagram of a license provisioning application operating in a computer/network environment according to embodiments herein. FIG. 2 includes a license management application 135, license provisioning application (OOBE Lib) 140, and local databases 181 including CAPS database 181-1, PCD database 181-2, and License Store 181-3. License management application 135 can operate as a stand-alone application or as a process accessible through currently installed applications. License provisioning application 140 is also referred to as OOBE Lib for brevity in subsequent example code snippets. The license provisioning application 140 generally includes a license manager along with a library to implement process steps to create a licensing data structure. The CAPS database 181-1 is an installer database and is also known as a master version of PCD database 181-2. PCD database 181-2 includes intermediate licensing information and product configuration data. License store 181-3 can be a database maintained on a desktop for storing exact license states of currently installed software products. Thus, it is a real license storage database.

Local databases 181 can also include a cache database for storing the licensing data structure for faster operation.

In step 191 in FIG. 2, license management application 135 requests licensing information from license provisioning application 140. In other words, license management application 135 submits a license query. Next, license provisioning application 140 queries local database 181 to gather license information for each software product in a group of software products. License provisioning application 140, in step 192, organizes licensing information into a license data structure, and then caches this information for future calls. In step 193, license provisioning application 140 transmits the licensing data structure to license management application 135. License management application 135 uses this licensing data structure, and associated licensing information in the licensing data structure, to determine and depict dependencies according to a predetermined business logic. License management application 135 can also allow or restrict a number of licensing operations. Such licensing operations can include status query, reporting, deactivation, and so forth.

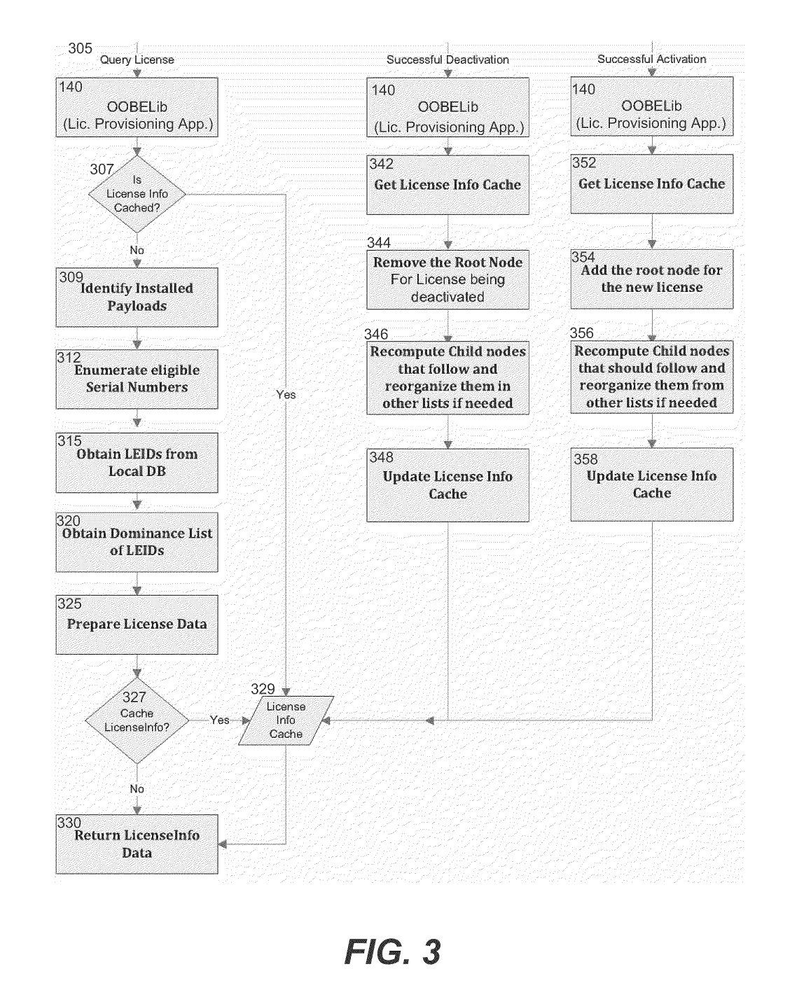

FIG. 3 is a flowchart illustrating an example of a process supporting a license provisioning application according to embodiments herein. In step 305, license provisioning application 140 receives a license query from a license management application or through an individual software application. In step 307, license provisioning application 140 can check to see if license information is cached. If license information has previously been cached, then license provisioning application 140 can continue to step 329 to obtain the cached license information. Assuming that this is the first license query for a particular machine, license provisioning application 140 determines that there is no cached licensing information.

In step 309, license provisioning application 140 identifies installed payloads. That is, identifying licensing information includes identifying installed payloads from a list of payload codes. Identifying installed payloads can include accessing a list of input payload codes, and searching for installed payloads. The input payload codes can be any predetermined group of software products. For example, the group can include all installed applications on a particular machine, all applications developed by a particular entity, all applications of a particular type, or any other predetermined group. License provisioning application 140 can create a list of installed payloads and associated licensing entity identifiers from the list of payload codes. The input payload codes can be stored in a database, and the payloads can be any installed software product/application.

More specifically, a payload is an installable part of an application. These payload codes are written into a master PCD database 181-2. Each particular version of a product can have a payload code associated with it. A database of payloads typically changes only when an application is installed or uninstalled.

Appearing below is an example code snippet for identifying installed payloads:

```
  bool
  LicenseManagementImpl::SetInstalledPayloads(const
char**inpayloads)
  {
    bool res = false;
    int i=0;
    char tempdata[512]={0};
    std::string leid=“”;
    if(inpayloads)
    {
      while(inpayloads[i])
      {
        //Get LicensingCode or LEID against
the
payload code value from master PCD
        if(!getValueFromPCD(tempdata, 512,
“LicensingCode”, inpayloads[i], kUseMasterPCD))
        {
            leid = tempdata;
mInstalledPayloads.insert(std::pair<std::string,std::string >
(inpayloads[i], leid) );
            tempdata[0]=‘\0’;
        }
          ++i;
        res = true;
      }
    }
    return res;
  }
```

In step 312, license provisioning application 140 enumerates eligible serial numbers as part of identifying licensing information. If installed payloads are found, then based on a license filtering criteria (e.g. only activated products; exclude trial products), license provisioning application 140 looks for all serial numbers that match the filtering criteria. License provisioning application 140 creates a list of all these serial numbers along with their license type. Serial numbers are gathered from an underlying License store 181-3.

Licensing a particular software product can include a two-step process. For some conventional software products, a serial number is entered during installation of the software product and is then transmitted to a backend server to validate the serial number. This is the activation process. The given software product can be in different states of activation. For example, the software product can be valid and activated, or valid and not activated. Thus, there can be different activation states. Consequently, in one embodiment the activation filter filters out different activation states of a given product.

For example, license provisioning application 140 can display applications that are both serialized and activated, as identifies from a license store 181-3 (which can include one ore more license servers that are either local or remote). Such license types can be trial, or unknown, or academic, or full, etc. In another example, license provisioning application 140 can exclude all of software products that have only a trial license.

Appearing below is an example code snippet for enumerating eligible serial numbers:

```
    bool
LicenseManagementImpl::EnumerateLicenseDBSerials(Adobe
_OOBELib_License_Type_Filter inFilter)
    {
      bool res = false;
      //This will retrieve all SN from the license db
which are of Activated
type.
    GetAllSerialNumbersFromLicenseDB(kLicenseType-
Filter_Activated, &mSerials);
    if(mSerials)
    {
        int i = 0;
          while(mSerials[i]!=0)
        {
    mListofAllSerials.push_back(mSerials[i]);
            mSerialToLicenseType.insert(std::pair<
std::string,
Adobe_OOBELib_LicenseType > (appserial ,
kOLLicenseType_Activated));
            ++i;
            res = true;
        }
    }
    //This will retrieve all SN from the license db
which are of Offline type
meaning not yet activated but makes the app run as
licensed as a valid SN
has been added.
    GetAllSerialNumbersFromLicenseDB(kLicenseType-
Filter_OfflineGrace,&mOffLineGraceSerials);
    if(mOffLineGraceSerials)
    {
        int i = 0;
    mListofAllSerials.push_back(mOffLineGraceSerials)
;
            mSerialToLicenseType.insert(std::pair<
std::string,
Adobe_OOBELib_LicenseType > (appserial ,
kOLLicenseType_OfflineGrace));
            ++i;
            res = true;
        }
            }
    return res;
  }
```

After identifying installed payloads and enumerating eligible serial numbers, license provisioning application 140 can begin populating licensing structure nodes with corresponding licensing information.

In step 315, license provisioning application 140 obtains license entity identifiers (LEIDs) from local databases 181, as part of identifying licensing information. A LEID is a unit that can be licensed. A LEID can be one payload, or can be a group of payloads. For serial numbers that match specified filtering criteria, license provisioning application 140 identifies a list of license entity identifiers on a particular machine by querying local database 181. License provisioning application searches for a value in a LEID map. If the value is different than the LEID being queried, then a corresponding LEID is being licensed by some other product entity. License provisioning application 140 thus obtains corresponding LEIDs for each licensing structure node.

Appearing below is an example code snippet for obtaining LEIDs from a local database:

```
  bool
  LicenseManagementImpl::EnumerateLEIDsFromPCD( )
  {
    bool res = false;
    getValueFromPCDAllSubdomains(mSublist, kUseCachePCD);
    int sz = ListSize(mSublist);
    if(sz)
    {
      const char * leid = ListNextString(mSublist);
      std::string newleid=“”, locale=“”;
      char value[512]={0};
      int foundindex=0, len=0;
      while(leid!=NULL)
      {
        //Query for “FLMap”. FLMap stores which leid
dominates the given leid
        if(!getValueFromPCD (value, 512, “FLMap”,
leid,kUseCachePCD))
        {
          newleid = leid;
    mCLEtoDomLE.insert(std::pair<std::string, std::string>
(newleid ,
value));
      }
      //Query for “SN” key. This stores the actual
Serial
number which was used to serialize and activate the leid
      if(!getValueFromPCD (value, 512, “SN”, leid,
kUseCachePCD))
      {
      //See if value is present in mSerials
  std::list<std::string>::iterator_iter=mListofAllSerials.-
begin( );
  for(;_iter!=mListofAllSerials.end( );++_iter)
      {
        if( _iter->find(value)
!=std::string::npos)
        {
          //remove the {|} stuff from leid
to get the locale. CLEID looks like leid{|}xx_YY
          newleid = leid;
          len = (int)newleid.size( );
          foundindex = newleid.find(“{|}”);
          locale =
newleid.substr(foundindex+3, len);
          if(mEligibleLocales.find(locale )
== mEligibleLocales.end( ))
          {
  mEligibleLocales.insert( std::pair< std::string,
std::string > (locale, “1”) );
          }
  mEligibleLEIDs.insert(std::pair<std::string,
std::string>(newleid.c_str( ),value));
  //Prepare the application name. This simply queries the
master pcd with newleid as the subdomain and EPIC_APP as
the key and puts it under mAppNameWithLEID
    PrepareAppName(newleid.c_str( ), value);
          }
        }
      }
      leid = ListNextString(mSublist);
    }
  }
  if(!mEligibleLEIDs.empty( ) && !mCLEtoDomLE.empty( ))
  {
    res = true;
    //Create mInstalledPayloadsWithCLEID
    std::map<std::string, std::string>::iterator
_iter1 = mInstalledPayloads.begin( );
    //For each leid in _iter->second( ) create a list
of leid{|}xx_YY where xx_YY is from mEligibleLocales
    for(;_iter1!=mInstalledPayloads.end( );++_iter1)
    {
      std::map<std::string, std::string
>::iterator _iter2 = mEligibleLocales.begin( );
      std::list < std::string > _list;
      std::string leid=“”;
  for(;_iter2!=mEligibleLocales.end( );++_iter2)
      {
        leid = _iter1->second;
        leid += “{|}”;
        leid += _iter2->first;
        _list.push_back(leid);
      }
      mInstalledPayloadsWithCLEID.insert(
std::pair <std::string, std::list < std::string > > (
_iter1->first , _list ) );
    }
  }
  return res;
}
```

In step 320, license provisioning application 140 obtains a dominance list of license entity identifiers, as part of identifying licensing information. For example, for each license entity identifier, license provisioning application 140 queries a database again to identify a dominating LEID as per a flexible licensing arrangement. License provisioning application 140 maintains a map of this LEID to a dominating LEID mapping.

For a dominating LEID, license provisioning application 140 identifies a local database to discover a committed serial number by searching for this serial number in the list of serial numbers created in step 312. From the LEID, license provisioning application 140 extracts a locale and adds this locale to a list of eligible locales if not already present. Obtaining a dominance list includes searching for an application name linked to this LEID and adds it to a map of LEIDs and application names. For the list of installed payloads (obtained in step 309), license provisioning application 140 creates a list of payloads with CLEIDs (LEID with locale) that map each installed payload with a list of LEIDs created from the payloads and eligible locales, from the list of eligible locales previously created. For this list of installed payloads, license provisioning application 140 iterates over the list of eligible LEIDs and checks if each LEID is being dominated by some other LEID or not. If the LEID is not present in the list of eligible LEIDs, then license provisioning application 140 identifies which LEID dominates this LEID by consulting the map of LEID and dominating LEID.

In other words, in step 320, license provisioning application 140 determines whether a particular program is self-licensed or licensed by a suite, and then associates each program with a correct licensing structure node. License provisioning application 140 determines which node to associate with a particular LEID by traversing the dominance list.

Appearing below is an example code snippet for obtaining a dominance list of LEIDs:

```
  bool
  LicenseManagementImpl::GetDominatedListOfLEIDs( )
  {
  bool res=true;
  std::map<std::string, std::list < std::string>
>::iterator _iter =
mInstalledPayloadsWithCLEID.begin( );
  std::list < std::string >::iterator _iter1 ;
  std::string dominance=“”;
  int sz=0;
  int i = 0;
  char data[512]={0},tempdata[512]={0};
  std::string domLE=“”;
  std::string leid=“”, serial=“”,locale=“”;
  int len=0,findIndex=0;
  for(;_iter!=mInstalledPayloadsWithCLEID.end( );++_iter)
  {
  std::list < std::string > _list = _iter->second;
_iter1 = _list.begin( );
  for(;_iter1!=_list.end( );++_iter1)
  {
  if( mEligibleLEIDs.find(*_iter1) == mEligibleLEIDs.end( )
)//meaning its
licensed by a dominating leid
  {
  //See if this leid is licensed or not
  if( mCLEtoDomLE.find(*_iter1) !=mCLEtoDomLE.end( ))
  {
  domLE = mCLEtoDomLE.find(*_iter1)->second;
  len = (int)domLE.size( );
  findIndex = (*_iter1).find(“{|}”);
  locale = (*_iter1).substr(findIndex+3, len);
  domLE+=“{|}”;
  domLE+=locale;
  std::list<std::pair<std::string,std::string> >
_pairlist;
_pairlist.push_back(std::pair<std::string,std::string>(_iter-
>first,*_iter1));
  if(mInstalledLicensedPayloads.find(domLE) ==
mInstalledLicensedPayloads.end( ))
  {
  //create
  leid = *_iter1;
  if(!leid.empty( ) && mEligibleLEIDs.find(domLE.c_str( ))
!=
mEligibleLEIDs.end( ))
  {
  serial=mEligibleLEIDs.find(domLE.c_str( ))->second;
  mInstalledLicensedPayloads.insert(std::pair<std::string,
std::list<std::pair<std::string,std::string> > > ( domLE ,
_pairlist));
  PrepareAppName( leid.c_str( ), serial.c_str( ) );
  }
  }
  else
  {
  leid = *_iter1;
  if(!leid.empty( ) && mEligibleLEIDs.find(domLE.c_str( ))
!=
mEligibleLEIDs.end( ))
  {
  serial=mEligibleLEIDs.find(domLE.c_str( ))->second;
mInstalledLicensedPayloads[domLE].push_back(std::pair<std::
string,std::string
>(_iter->first,*_iter1));
  PrepareAppName((*_iter1).c_str( ), serial.c_str( ));
  }
  }
  }
  }
  }
  }
  return res;
  }
```

In step 325, license provisioning application 140 prepares license data. For the list of eligible LEIDs, license provisioning application prepares a licensing data structure. Each LEID corresponds to a node of the licensing data structure, and can include an application name, LEID, whether the application is self-licensed, a license type, a payload code, a serial number, a trial duration, a trial time left, etc. All installed LEIDs being dominated by a particular node are linked to that node. The LEIDs or applications that are self-licensed will be present in a main root node, and any other applications that are licensed by a suite can be present in a next/dependent field or child node of the root node.

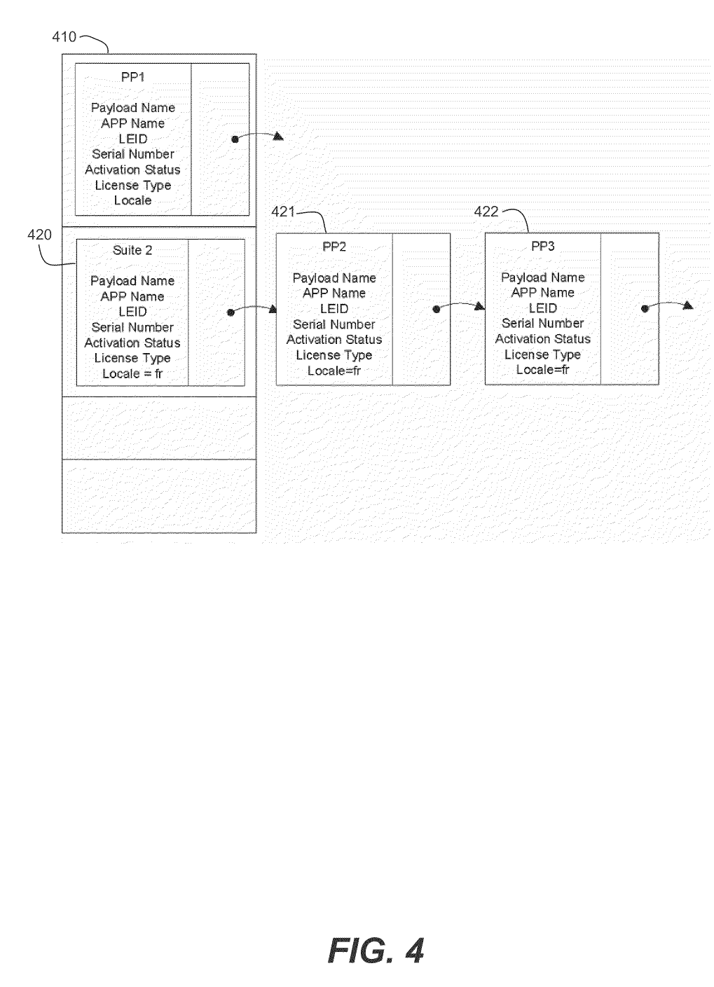

FIG. 4 is a diagram that illustrates how licensing information for a given machine at a given time can be organized as an array of list nodes. Each of boxes or nodes corresponds to a license to a particular product and particular locale. The term “PP” stands for “point product,” which is an independent application that can be either self-licensed or licensed by a suite. For example, a graphics editor application could be a point product while a collection or group of software products can be a suite. There are several numbered point products referenced in FIGS. 4-6. Root node 410 represents PP1 (point product 1), root node 420 represents Suite 2, and child nodes 421 and 422 represent point products PP2 and PP3 respectively.

For example, if the graphics editor were licensed by itself, then there would be a single node for the graphics editor, such as PP1. The example graphics editor can also be licensed by a suite serial number. In this case, license provisioning application 140 includes a separate row with a child node that points to a suite node. For example, a head node 420 lists Suite 2 and points to two child nodes (PP2 and PP3).

The root of each list corresponds to an actual license that has a valid serial number and has been activated through the activation server. Also, there can be a license document present associated with the node in the local database 181. Child nodes for each list correspond to a product or component that is dominated or licensed by the root node. Any payload/software product can be part of multiple lists, or can be a root node itself. A single product licensed by itself can be denoted by a single node at the root level of the list. Typically, license provisioning application 140 is based on the license states of products and not based on install states. So a product may be installed, but if it is not licensed then the unlicensed product can be excluded from the array.

For example, a user installs the graphics editor and the desktop publisher. Upon launching these applications, the user enters a serial number for a software suite. In this example scenario, the array tree structure will look like a root node that points to the software suite, with two child nodes—one child node for the graphics editor, and one child node for the desktop publisher. In another example, the graphics editor may already be installed individually before installing the graphics editor as part of a suite. If a particular point product or individual application is previously installed with a serial number separate from a serial number for a suite, then that point product will have its own root node.

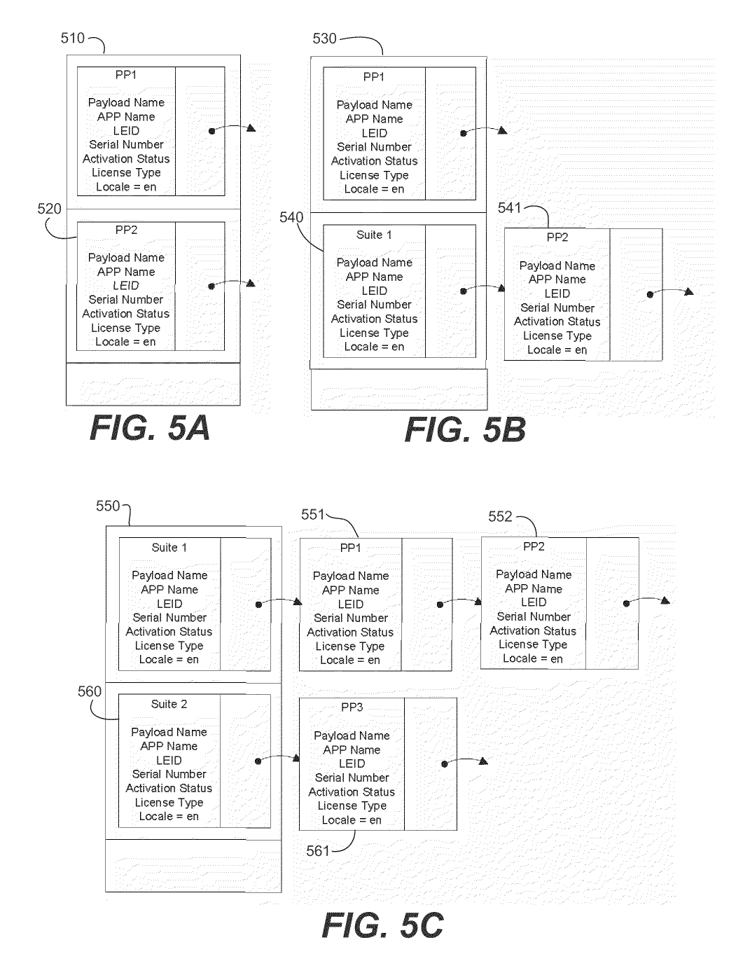

FIGS. 5A-5B illustrate various licensing data structures possible on a given machine. FIG. 5A illustrates an example where PP1 (root node 510) and PP2 (root node 520) are both licensed by themselves and not part of a software suite. Thus, PP1 and PP2 are both root nodes in this example. FIG. 5B illustrates an example where PP1 (root node 530) is licensed by itself, while PP2 (node 541) is licensed by Suite 1 (root node 540).

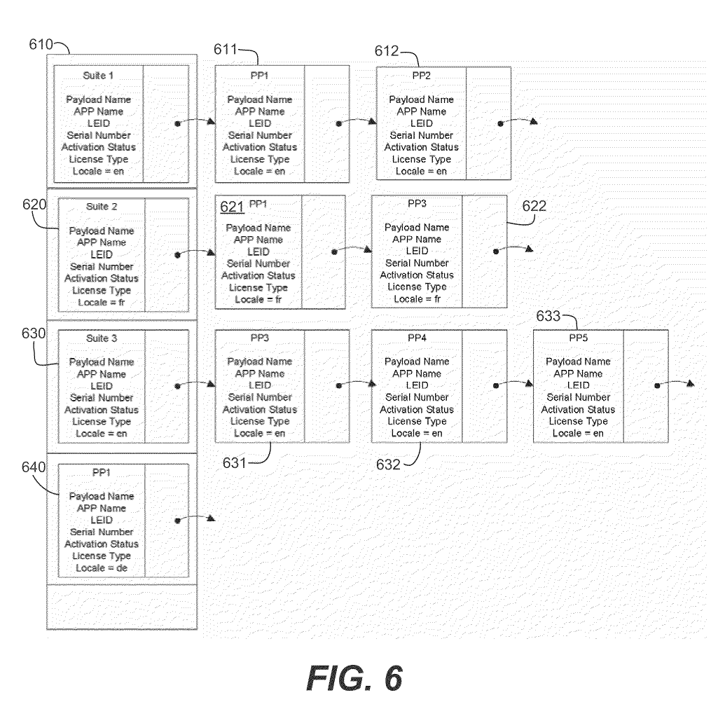

FIG. 5C illustrates an example of locale-based licensing. In FIG. 5C, PP1 (node 551) and PP2 (node 552) are both licensed by Suite 1 (root node 550) with a locale listed as “en” or English. PP3 (node 561) is licensed by Suite 2 (root node 560) and also licensed in English. FIG. 6 will illustrate an example of multiple different locales.

FIG. 6 illustrates a more complex licensing data structure array having multiple locales. In FIG. 6, PP1 of node 611 and PP2 of node 612 are licensed in English by Suite 1 (root node 610). PP1 of node 621 and PP3 of node 622 are licensed in French (locale=fr) and are licensed by Suite 2 (root node 620). PP3 of node 631, PP4 of node 632, and PP5 of node 633 are all licensed in English by Suite 3 (root node 630). PP1 of root node 640 is self-licensed in German (locale=de). FIG. 6 is an example of how licensing complexity can increase as the number of products, languages, and active licenses present on a machine increases. The licensing data structure of license provisioning application 140, however, can facilitate building up more complex licensing operations like license management and deactivation.

Generally, if a given point product is licensed by itself, and then subsequently installed from a software suite that also includes this point product, then the point product does not switch to the suite license. For example, a user installs the graphics editor then the desktop publisher, and then submits a corresponding serial number for each product. Subsequently, the user installs a suite of several products, and the suite includes the graphics editor and the desktop publisher. The user submits a serial number to activate the suite. Since the graphics editor and the desktop publisher are already licensed by individually, then these applications would not switch to the suite license.

In most embodiments, a product is licensed by one entity. Each product can be licensed by itself, or can be licensed by a suite. A common scenario is a situation where a user already has a point product installed and in use on a machine, and then installs a suite to access additional products. The point product now has two licenses on the machine. Thus, for most embodiments, the license for the individual point product would need to be deactivated by removing a corresponding serial number from database 181-3. Then the point product would switch to the suite license, which is already activated.

Note that license provisioning application 140 can be used just for gathering license information. This means that individual programs/software products will launch and operate because they are already licensed. This data structure is used to present relationships of all licensed products including locale-based licensing. By the time the data structure is organized and accessible, a particular point product has already been activated.

Appearing below is an example code snippet useful for preparing the licensing data structure:

```
bool
LicenseManagementImpl::PrepareLicenseData( )
{
      std::map<std::string, std::string>::iterator _iter =
    mEligibleLEIDs.begin( );
      LicenseType outLicType;
      int outDuration=0;
      int outRemainingDays=0;
      const char *outUsrDict=0;
      Adobe_OOBELib_LicenseInfo_Struct _struct,
    *temp=0,*tempnext=0;
      int i=0,sz=0;
      for(;_iter!=mEligibleLEIDs.end( );++_iter)
      {
    //Get the license info associated with the serial
    number from license
    db
          QueryLicenseInfoFromLicenseDB (_iter-
        >second.c_str( ),
        &outLicType, &outDuration,
        &outRemainingDays,&outUsrDict);
          //Store the App Name
          _struct._appname = GetAppName(_iter-
        >first.c_str( ));
          //Store the CLEID i.e leid{|}xx_YY
          _struct._leid = _iter->first.c_str( );
          //Since it's the root node its always licensed
        by self
          _struct._licensedbyself = true;
          //License type activated or offline
          _struct._lictype = mSerialToLicenseType[_iter-
        >second];
          //Payload code could be NULL if not installed
          _struct._payload=GetAppPayload(_iter-
        >first.c_str( ));
          //Encrypted serial number
          _struct._serialnumber = _iter->second.c_str( );
          _struct._trialduration=outDuration;
          _struct._trialleft = outRemainingDays;
        if(mInstalledLicensedPayloads.find(_struct._leid)
        !=
        mInstalledLicensedPayloads.end( ))
          {
            std::list<std::pair<std::string,std::string>
            >::iterator
            _iterlist =
            mInstalledLicensedPayloads.find(_struct._leid
            )-
            >second.begin( );
              std::pair<std::string,std::string> _pair;
              i=0;
            sz=mInstalledLicensedPayloads.find(_struct._leid)-
            >second.size( );
              //Prepare the child nodes which are
            licensed by the root
              tempnext = new
            Adobe_OOBELib_LicenseInfo_Struct;
              tempnext->_next=0;
              temp=tempnext;
              for(;i<sz &&
            _iterlist!=mInstalledLicensedPayloads.find(_struct._leid
            )->second.end( );++i,++_iterlist)
              {
                  tempnext->_appname =
                GetAppName(_iterlist-
                >second.c_str( ));
                  tempnext->_leid = _iterlist-
                >second.c_str( );
                  tempnext->_licensedbyself = false;
                  tempnext->_lictype =
                mSerialToLicenseType[_iter-
                >second];//kOLLicenseType_Activated;
                  tempnext->_payload=_iterlist-
                >first.c_str( );
                  tempnext->_serialnumber = _iter-
                >second.c_str( );
                  tempnext->_trialduration=outDuration;
                  tempnext->_trialleft =
                outRemainingDays;
                AMTLog(LicenseManagementImpl::m_OOBELib
                LoggingSvcRef,kLogGroup,
                AMTLogLevelInformational,kDontObscure,“
                Child LEID %s”,tempnext->_leid);
                  if(i<sz−1)
                  {
                      tempnext->_next = new
                    Adobe_OOBELib_LicenseInfo_Struct;
                      tempnext->_next->_next=0;
                      tempnext = tempnext->_next;
                  }
              }
              _struct._next = temp;
              temp=0;
          }
          else
              _struct._next=0;
          mLicenseInfoList.push_back(_struct);
      }
      return true;
}
```

License provisioning application 140 can use various process structures and components for executing the steps thus far. For example, components can include a map of eligible LEIDs, a map of application name and LEID, a list of active serial numbers, a list of installed payloads, and vector storing license information. Other components can include a map storing a list of CLEID (LEID with locale) against installed payload codes, a map of CLEIDs to dominating LEID, a map storing a list of pairs with each pair storing a CLEID and serial number against an installed payload code, a map of eligible locales, and a map of serial number and associated license type, among other lists and maps.

In steps 327 and 329, license provisioning application 140 optionally caches the licensing data structure to improve performance. By caching the licensing data structure, license provisioning application 140 accelerates processing of subsequent license queries. The licensing data structure is dynamic and can be selectively updated on deactivation and serialization calls. The cached information does not need to be used for licensing libraries or activation routines. Instead, the cached information can be used to depict license states and dependencies. For example, in a case of deactivation of a license, the entire list can be deleted from the cache, and the nodes that follow in the list can be rearranged into new nodes. In the case of a new license being activated on a system, a rescan for the nodes dominated by this license can be re-structured accordingly.

FIG. 3 also includes a flow chart for deactivating and activating processes. For deactivation, license provisioning application 140 accesses license information from the cache (step 342). In step 344, license provisioning application 140 removes a corresponding root node for a given license being deactivated. In step 346, license provisioning application 140 recomputes child nodes that follow, and reorganizes the child nodes in other lists in the license structure data array, if needed. In step 348, the updated license information is cached.

For activation, license provisioning application 140 accesses license information from the cache (step 352). In step 354, license provisioning application 140 adds a root node for a given new license. In step 356, license provisioning application 140 recomputes child nodes that should follow, and reorganizes these nodes from other lists, if needed. In step 358, the updated license information is cached.

The licensing data structure can be stored or cached in an XML format. Below appears an example format:

```
<LicenseInfo>
    <License>
        <Root>
            <AppName></AppName>
            <LEID></LEID>
            ...
            <Children>
                <Child>
                    <AppName>< /AppName>
                    <LEID></LEID>
                    ...
                </Child>
                <Child>
                    <AppName></AppName>
                    <LEID></LEID>
                    ...
                </Child>
        ...
        ...
            </Children>
        </Root>
        ...
        ...
    </License>
</LicenseInfo>
```

This example XML can be cached in a cache PCD for subsequent queries. This XML can be updated under several conditions, such as a deactivation or activation. In the deactivation example, license provisioning application 140 removes an affected root node and its associated child nodes from the XML, and returns modified XML. In the activation example, license provisioning application 140 can add a new node (for a new license) and child node (if any), or add a new child in an existing node, such as tied to a suite node.

In step 330, license provisioning application returns the licensing data structure for usage, such as license management operations. Three common usage operations include: (1) uninstalling a product, (2) deactivating a product, and (3) creating a license management application.

License provisioning application 140 uses the licensing data structure to create a graphical user interface for displaying relationships among software products, and for receiving input for license management operations.

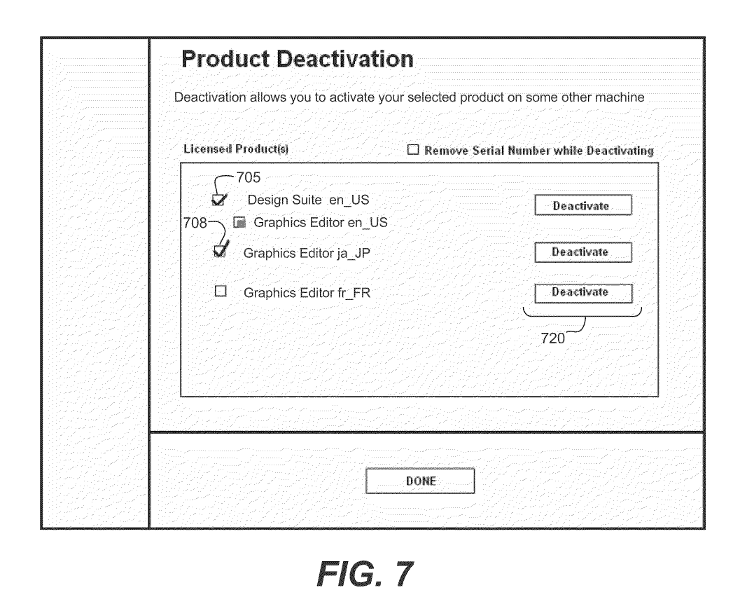

FIG. 7 is an illustration of a screenshot of an example graphical user interface for product deactivation. In response to entering a deactivation mode, license provisioning application 140 queries all products which are licensed and available on a particular desktop or machine. This includes gathering information for a particular product and traversing through or collecting information for all locales and for flexible licensing structures. License provisioning application 140 can then access or calculate license dependencies for graphically displaying accurate content.

The example screenshot of FIG. 7 then shows a graphical user interface for manual product deactivation, and show exact license dependencies and options for deactivating different language instances of a given product. Note that check box 705 and check box 708 are selected. Selecting checkbox 705 can be used to deactivate a suite of software products (“Design Suite”), which, in this example, includes an English version of the Graphics Editor. Deactivation can be initiated using buttons 720. Selecting checkbox 708 can be used to deactivate a self-licensed point product of a specific locale. In this example, the point product is a Japanese language version of Graphics Editor.

For one example embodiment of deactivation, refer to FIG. 5B. In this example, PP1 of node 530 might be a graphics editor. Suite 1 of node 540 might be a collection of applications that includes the graphics editor, PP1, and a desktop publisher, PP2 of node 541. In this example, the graphics editor PP1 is installed first (in time), and then activated as a self-licensed application. Subsequently, Suite 1 of node 540 is installed and activated. During the activation of Suite 1, a corresponding suite-based license for the desktop publisher is activated, while a corresponding suite-based licensed may or may not be activated for PP1, yet a suite-based license for PP1 is stored in license store 181-3. Thus, FIG. 5B represents a license structure for license management and for generating a graphical display of license-application relationships. A device operator can then access a deactivation screen, and choose to deactivate the graphics editor PP1 of node 580. After deactivation, and upon subsequently launching the graphics editor, the graphics editor PP1 now uses the suite-based license as permission to be executed. Upon recalculating the licensing data structure of FIG. 5B, the node 580 for PP1 would be removed, and a new node would appear to the right of node 540 for PP1. Thus, graphics editor PP1 would still be licensed, but is now is no longer self-licensed, but instead licensed via Suite 1 of node 540.

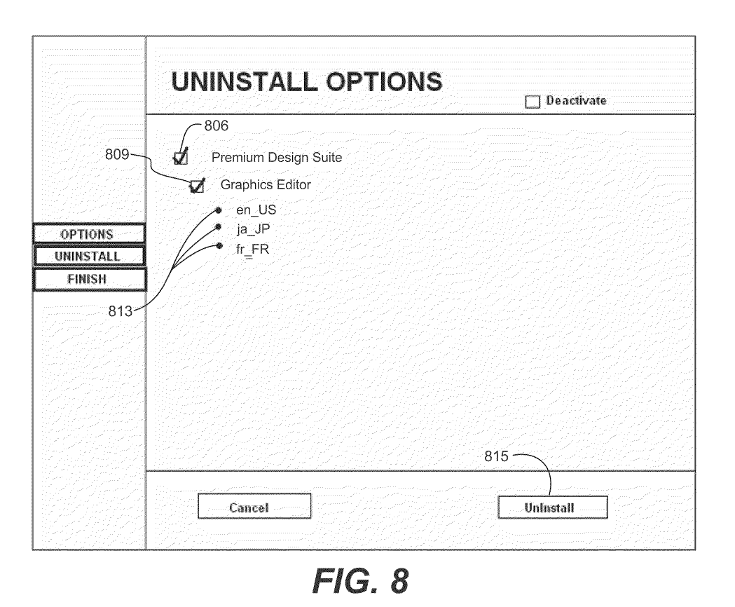

FIG. 8 is an illustration of a screenshot of an example graphical user interface for uninstalling software products. In this example, the screenshot shows an option for uninstalling “Premium Design Suite” by deactivating and removing a license for all three languages of Graphics Editor. Specifically, in this example, checkbox 806 shows selection of a particular software suite called “Premium Design Suite.” Below this suite next to checkbox 809 is Graphics Editor. Below the Graphics Editor appear radio buttons 113, which enable selection of locale-based point products. In this example, the locales include English, Japanese, and French. Any or all of these locales can be selected for uninstalling corresponding applications. Button 815 can be used to initiate removal of selected applications.

During uninstall of a suite, a caller can traverse corresponding roots and search of the suite payload code to identify the index and then continue. If two root nodes are identified with a suite payload code, then license provisioning application 140 can call a deactivate API with an array of pointers.

For licensing management operations, license provisioning application 140 can also display complex relationships among licensed applications on a machine. For convenience in describing example embodiments, the example screen shots showed only a few applications. In other embodiments, the license management screen can be large and complex showing many or all relationships in a tree-like structure. Such a tree-like structure helps operators to quickly understand or visualize which licenses are on a machine or are available on a machine, and which licenses of the available licenses are currently being used for a particular suite of products or individual product or group products.

Those skilled in the art will understand that there can be many variations made to the operations of the user interface explained above while still achieving the same objectives of the invention. Such variations are intended to be covered by the scope of this invention. As such, the foregoing description of embodiments of the invention are not intended to be limiting. Rather, any limitations to embodiments of the invention are presented in the following claims.

1. A computer-implemented method comprising:
identifying, by a processor, licensing information for a plurality of software products, the licensing information located at multiple storage locations, each software product in the plurality having at least one licensing entity identifier;
creating, by the processor, a licensing structure node for each of multiple identified licensing entity identifiers, and populating each licensing structure node with corresponding licensing information from the multiple storage locations;
organizing, by the processor, the licensing structure nodes into a hierarchical licensing data structure based on dominance relationships among the licensing structure nodes; and
executing license management for the plurality of software products using the licensing structure nodes and the hierarchical licensing data structure.

2. The computer-implemented method of claim 1, wherein identifying licensing information includes identifying installed payloads from a list of payload codes, the payloads defining an installable portion of a software product.

3. The computer-implemented method of claim 2, wherein identifying licensing information includes enumerating serial numbers of installed payloads and filtering serial numbers to identify serial numbers that match filtering criteria, the enumerated serial numbers including a license type.

4. The computer-implemented method of claim 1, wherein identifying licensing information includes obtaining a dominance list of licensing entity identifiers.

5. The computer-implemented method of claim 4, wherein obtaining the dominance list includes:
querying a licensing database to identify a dominating licensing entity identifier according to a licensing strategy; and
maintaining a map of dominating licensing entity identifiers.

6. The computer-implemented method of claim 5, wherein obtaining the dominance list includes:
for a dominating licensing entity identifier, identify a committed serial number from the local database; and
extracting a locale of the licensing entity identifier, wherein the dominance list identifies a priority order of the software products based on installation date, serial numbers, and locale.

7. The computer-implemented method of claim 5, wherein obtaining the dominance lists includes:
creating a list of payloads with licensing entity identifiers; and
mapping each installed payload with a list of licensing entity identifiers created from the payloads and corresponding locales.

8. The computer-implemented method of claim 7, wherein obtaining the dominance list includes iterating through the mapping of installed payloads to determine whether each licensing entity identifier is dominated by another licensing entity identifier.

9. The computer-implemented method of claim 1, wherein identifying licensing information includes:
identifying installed software products, enumerating serial numbers, identifying licensing entity identifiers, and obtaining a dominance list of licensing entity identifiers;
wherein creating a licensing structure node for each software product includes:
creating fields for software product name, licensing entity identifier, serial number, activation status, license type, and locale;
wherein executing license management includes:
providing a graphical user interface for de-activating and activating software product licenses.

10. The computer-implemented method of claim 1, further comprising:
storing the licensing information structure in a cache;
in response to deactivation of a license, re-computing the hierarchical licensing data structure in the cache; and
in response to activation of a new license, rescanning nodes dominated by the new license and restructuring affected nodes in the cache.

11. A computer program product including a computer-storage medium having instructions stored thereon for processing data information, such that the instructions, when carried out by a processing device, cause the processing device to perform the operations of:
identifying licensing information for a group of software products, the licensing information located at multiple storage locations, each software product in the group having at least one licensing entity identifier;
creating a licensing structure node, for each of multiple identified licensing entity identifier, and populating each licensing structure node with corresponding licensing information from the multiple storage locations;
organizing the licensing structure nodes into a hierarchical licensing data structure based on dominance relationships among the licensing structure nodes; and
executing license management for the group of software products using the licensing structure nodes and the hierarchical licensing data structure.

12. The computer program product of claim 11, wherein identifying licensing information includes identifying installed payloads from a list of payload codes, the payloads defining an installable portion of a software product.

13. The computer program product of claim 12, wherein identifying licensing information includes enumerating serial numbers of installed payloads and filtering serial numbers to identify serial numbers that match filtering criteria, the enumerated serial numbers including a license type.

14. The computer program product of claim 11, wherein identifying licensing information includes obtaining a dominance list of licensing entity identifiers.

15. The computer program product of claim 14, wherein obtaining the dominance list includes:
querying a licensing database to identify a dominating licensing entity identifier according to a licensing strategy; and
maintaining a map of dominating licensing entity identifiers.

16. The computer program product of claim 15, wherein obtaining the dominance list includes:
for a dominating licensing entity identifier, identify a committed serial number from the local database; and
extracting a locale of the licensing entity identifier, wherein the dominance list identifies a priority order of the software products based on installation date, serial numbers, and locale.

17. The computer program product of claim 15, wherein obtaining the dominance lists includes:
creating a list of payloads with licensing entity identifiers;
mapping each installed payload with a list of licensing entity identifiers created from the payloads and corresponding locales; and
iterating through the mapping of installed payloads to determine whether each licensing entity identifier is being dominated by another licensing entity identifier.

18. The computer program product of claim 11, wherein identifying licensing information includes:
identifying installed software products, enumerating serial numbers, identifying licensing entity identifiers, and obtaining a dominance list of licensing entity identifiers;
wherein creating a licensing structure node for each software product includes:
creating fields for software product name, licensing entity identifier, serial number, activation status, license type, and locale;
wherein executing license management includes:
providing a graphical user interface for de-activating and activating software product licenses.

19. The computer program product of claim 11, further comprising:
storing the licensing information structure in a cache;
in response to deactivation of a license, re-computing the hierarchical licensing data structure in the cache; and
in response to activation of a new license, rescanning nodes dominated by the new license and restructuring affected nodes in the cache.

20. A computer system comprising:
a processor;
a memory coupled to the processor, the memory storing instructions that when executed by the processor cause the system to perform the operations of:
identifying licensing information for a group of software products, the licensing information located at multiple storage locations, each software product in the group having at least one licensing entity identifier;
creating a licensing structure node, for each of multiple identified licensing entity identifier, and populating each licensing structure node with corresponding licensing information from the multiple storage locations;
organizing the licensing structure nodes into a hierarchical licensing data structure based on dominance relationships among the licensing structure nodes; and
executing license management for the group of software products using the licensing structure nodes and the hierarchical licensing data structure.

21. The method of claim 1 wherein the hierarchical licensing data structure comprises:
root nodes for individually installed applications and application suites; and
child nodes for applications licensed within the application suites.

22. The computer-implemented method of claim 1, further comprising graphically displaying the licensing structure nodes on a user interface.

23. The computer-implemented method of claim 1, wherein dominance relationship exists when a point product is part of a suite of products and the license of the suite product can be used to license the point product.

24. The computer-implemented method of claim 1, wherein dominance relationship exists when a first license associated with a first product can be licensed by a second product.

25. The computer-implemented method of claim 1, wherein the hierarchical licensing data structure comprises root nodes for individually installed applications.

26. The computer-implemented method of claim 1, wherein the hierarchical licensing data structure comprises root nodes for application suites and child nodes for applications licensed within a suite.

27. The computer-implemented method of claim 1, wherein the hierarchical licensing data structure is organized as an array of linked nodes.

28. The computer-implemented method of claim 1, wherein the hierarchical licensing data structure includes a root node that corresponds to a self-licensed product that corresponds to a valid serial number, activated by a license server.
